(19) United States
(12) Patent Application Publication
(10) Pub. No.: US 2002/0029387 A1
(43) Pub. Date: Mar. 7, 2002

(54) Television receiver, remote controller for television receiver, and service providing system

(76) Inventor: Youichiro Nishikawa, Katano City (JP)

Correspondence Address: SMITH, GAMBRELL & RUSSELL, LLP, 1850 M STREET, N.W., SUITE 800, WASHINGTON, DC, 20036, US

(21) Appl. No.: 09/748,389

(22) Filed: Dec. 27, 2000

(30) Foreign Application Priority Data
Dec. 28, 1999 (JP) 11-375054

(51) Int. Cl. G06F 3/00; H04N 5/445; G06F 13/00; H04N 7/173

(52) U.S. Cl. 725/61; 725/87

(57) ABSTRACT

A television receiver comprises means for acquiring program-related information related to the contents of each program corresponding to a predetermined time period from a first server through a network, means for displaying, when the program is selected by a user, the program-related information corresponding to the program on a television monitor, means for acquiring, when an anchor for link information included in the displayed program-related information is selected by a user operation, the detailed information from a second server through the network on the basis of the link information, and means for displaying the acquired detailed information on the television monitor.

### BACKGROUND OF THE INVENTION

1. Field of the Invention

The present invention relates to a television receiver, a remote controller for the television receiver, and a service providing system.

2. Description of the Prior Art

A so-called Internet television having the function of acquiring and displaying a home page on the Internet has already been developed. However, such a system that information related to the contents of a program (a TV program) which is being viewed by a television receiver is acquired by the television receiver through the Internet and is timely displayed has not been constructed yet.

Furthermore, commodity purchase information which is synchronized with a program has not been constructed yet.

### SUMMARY OF THE INVENTION

An object of the present invention is to provide a television receiver so adapted that information related to the contents of a program which is being viewed by a television receiver can be acquired through the Internet by the television receiver and timely displayed.

Another object of the present invention is to provide a service providing system so adapted as to timely provide commodity purchase information which is synchronized with a program.

A first television receiver according to the present invention is characterized by comprising means for acquiring program-related information held in a first server connected to a network and related to the contents of each program corresponding to a predetermined time period and including link information for acquiring detailed information held in a second server connected to the network from the first server through the network and storing the acquired program-related information; means for displaying, when the program is selected by a user, the program-related information corresponding to the program on a television monitor; means for acquiring, when an anchor for the link information included in the displayed program-related information is selected by a user operation, the detailed information from the second server through the network on the basis of the link information; and means for displaying the acquired detailed information on the television monitor.

A second television receiver according to the present invention is characterized by comprising means for acquiring program-related information held in a first server connected to a network and related to the contents of each program corresponding to a predetermined time period from the first server through the network and storing the acquired program-related information; and means for displaying, when the program is selected by a user, the program-related information corresponding to the program on a display device provided in a remote controller for the television receiver.

It is preferable that the television receiver comprises means for acquiring EPG (Electronic Program Guide) information related to a program schedule corresponding to a predetermined time period from a second server connected to the network and storing the acquired EPG information, and means for displaying, when the power is turned on or a program which is being viewed is terminated, a program table created on the basis of the ERG information on the display device provided in the remote controller for the television receiver.

The program-related information includes program-related information for each elapsed time period in each program, for example.

The program-related information includes program-related information for each elapsed time period in each program, for example.

It is preferable that the program-related information includes link information for acquiring detailed information held in a third server connected to the network, and the television receiver further comprises means for acquiring, when an anchor for the link information is selected by a user operation, the detailed information from the third server through the network on the basis of the link information, and means for displaying the acquired detailed information on the display device provided in the remote controller for the television receiver.

A remote controller for a television receiver according to the present invention is characterized by comprising a display device; means for acquiring program-related information related to the contents of each program corresponding to a predetermined time period from a first server connected to a network and storing the acquired program-related information; and means for displaying, when the program is selected by a user, the program-related information corresponding to the program on the display device.

It is preferable that the remote controller for a television receiver comprises means for acquiring EPG information related to the program schedule corresponding to a predetermined time period from a second server connected to the network and storing the acquired EPG information, and means for displaying, when the power is turned on or a program which is being viewed is terminated, a program table created on the basis of the EPG information on a display device.

The program-related information includes program-related information for each elapsed time period in each program, for example.

It is preferable that the program-related information includes link information for acquiring detailed information held in a third server connected to a network, and the remote controller for a television receiver further comprises means for acquiring, when an anchor for the link information is selected by a user operation, the detailed information from the third server through the network on the basis of the link information, and means for displaying the acquired detailed information on the display device.

In a service providing system comprising a television receiver having a first server connected to a network and holding program-related information related to the contents of each program, a second server holding detailed information, and a network connecting function, the program-related information including link information for a acquiring the detailed information, a first service providing system according to the present invention is characterized in that the television receiver comprises means for acquiring the program-related information related to the contents of each program corresponding to a predetermined time period from the first server and storing the acquired program-related information, means for displaying, when the program is selected by a user, the program-related information corresponding to the program on a television monitor, means for acquiring, when an anchor for the link information included in the program-related information is selected by a user operation, the detailed information from the second server on the basis of the link information, and means for displaying the acquired detailed information on the television monitor. The detailed information includes commodity purchase information, for example.

In a service providing system comprising a television receiver having a first server connected to a network and holding program-related information related to the contents of each program, a second server holding detailed information, and a network connecting function, the program-related information including link information for acquiring the detailed information, a second service providing system according to the present invention is characterized in that the television receiver comprises means for acquiring the program-related information related to the contents of each program corresponding to a predetermined time period from the first server and storing the acquired program-related information, means for displaying, when the program is selected by a user, the program-related information corresponding to the program on a display device provided in a remote controller for the television receiver, means for acquiring, when an anchor for the link information included in the program-related information is selected by a user operation, the detailed information from the second server on the basis of the link information, and means for displaying the acquired detailed information on the display device provided in the remote controller for the television receiver. The detailed information includes commodity purchase information, for example.

In a service providing system comprising a remote controller for a television receiver having a first server connected to a network and holding program-related information related to the contents of each program, a second server holding detailed information, and a network connecting function, the program-related information including link information for acquiring the detailed information, a third service providing system according to the present invention is characterized in that the remote controller for the television receiver comprises means for acquiring the program-related information related to the contents of each program corresponding to a predetermined time period from the first server and storing the acquired program-related information, means for displaying, when the program is selected by a user, the program-related information corresponding to the program on the display device, means for acquiring, when an anchor for the link information included in the program-related information is selected by a user operation, the detailed information from the second server on the basis of the link information, and means for displaying the acquired detailed information on the display device. The detailed information includes commodity purchase information, for example.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a service providing system;

FIG. 2 is a schematic view showing an example of a description format for EPG information;

FIG. 3 is a schematic view showing an example of a description format for program-related information;

FIG. 4 is a flow chart showing an example of the procedure for service utilization by a service providing system;

FIG. 5 is a schematic view showing an example of a screen on which initial screen description information is displayed (an initial screen);

FIGS. 6(a) and 6(b) are schematic views respectively showing an example of a screen on which scene description information is displayed;

FIG. 7 is a schematic view showing an example of a screen on which service information is displayed;

FIG. 8 is a schematic view showing an example of display in a case where information required to purchase a service is inputted on a screen on which service purchase information is displayed;

FIG. 9 is a sequence diagram showing the procedure for communication between a remote control system 20 and a television system 10 which is established in order to display program-related information;

FIG. 10 is a sequence diagram showing the procedure for communication between a remote control system 20 and a television system 10 in a case where the remote control system 20 does not comprise a storage device and an internal clock device; and

FIG. 11 is a sequence diagram showing the procedure for communication between a remote control system 20, a television system 10 , and a server 40 in a case where service information is acquired from a server and displayed and a case where service purchase information is transmitted to a server.

### DETAILED DESCRIPTION OF THE PREFERRED EMBODIMENTS

Referring now to the drawings, an embodiment of the present invention will be described.

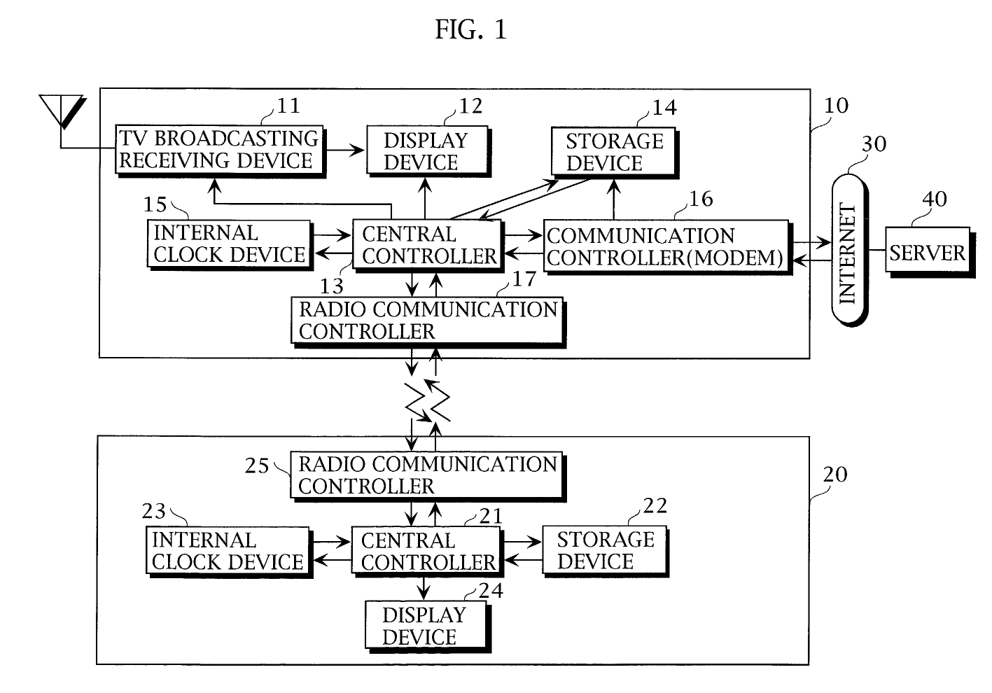

FIG. 1 illustrates the configuration of a service providing system using a television receiver.

The television receiver comprises a television system 10 having the function of communicating with the Internet 30 and a remote control system 20. A server 40 operated by a service operating company exists on the Internet 30.

The television system 10 comprises a television broadcasting receiving device 11, a display device 12, and a central controller 13. The central controller 13 comprises a storage device 14 and an internal clock device 15. A communication controller (a modem) 16 for establishing communication with the server 40 on the Internet 30 is connected to the central controller 13, and a radio communication controller 17 for establishing communication with the remote control system 20 is connected thereto.

The remote control system 20 comprises a central controller 21. The central controller 21 comprises a storage device 22 and an internal clock device 23. A display device 24 and a radio communication controller 25 for establishing communication with the television system 10 are connected to the central controller 21.

The server 40 stores EPG information related to a program schedule, program-related information related to the contents of a program, and service information related to the program-related information.

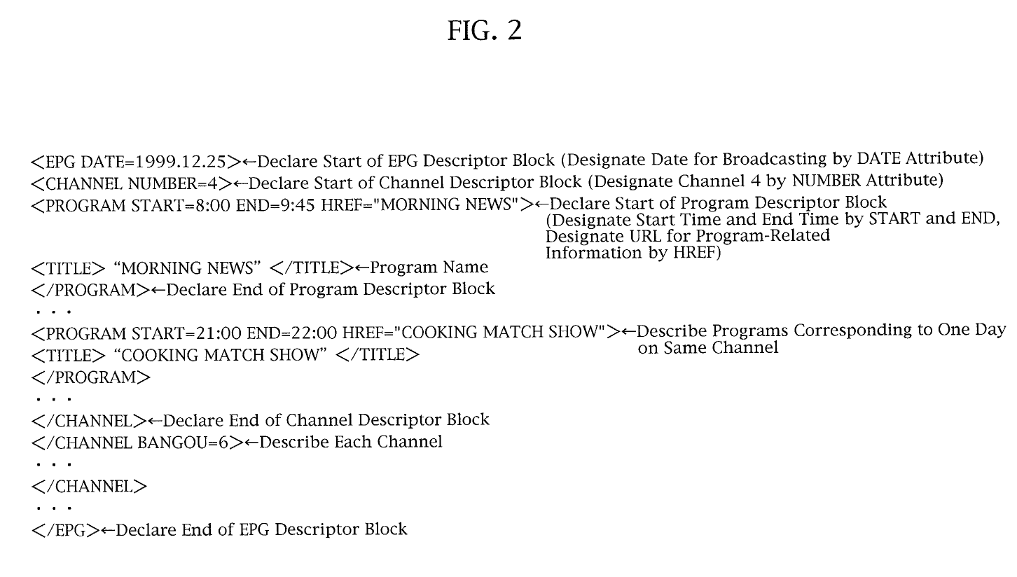

FIG. 2 illustrates an example of a description format for EPG information.

The EPG information is described in an HTML (Hypertext Markup Language) format in principle. In this example, the following tags are added:

(1) A tag representing the start and the end of an EPG descriptor block (a block for describing EPG information corresponding to one day)

<EPG DATA=00000000>˜</EPG>

00000000: the date to which the EPG is applied

(2) A tag representing the start and the end of a channel descriptor block (a block for describing program information corresponding to a particular channel)

<CHANNEL NUMBER=000; >˜</CHANNEL>

000: channel number

(3) A tag representing the start and the end of a program descriptor block (a block for describing program information corresponding to one program)

<PROGRAM START=0000 END=XXXX HREF=“????”>˜</PROGRAM>

000: start time to display the program-related information defined with HREF statement

XXXX: end time to display the program-related information defined with HREF statement

????: URL (Uniform Resource Locator) for the program-related information

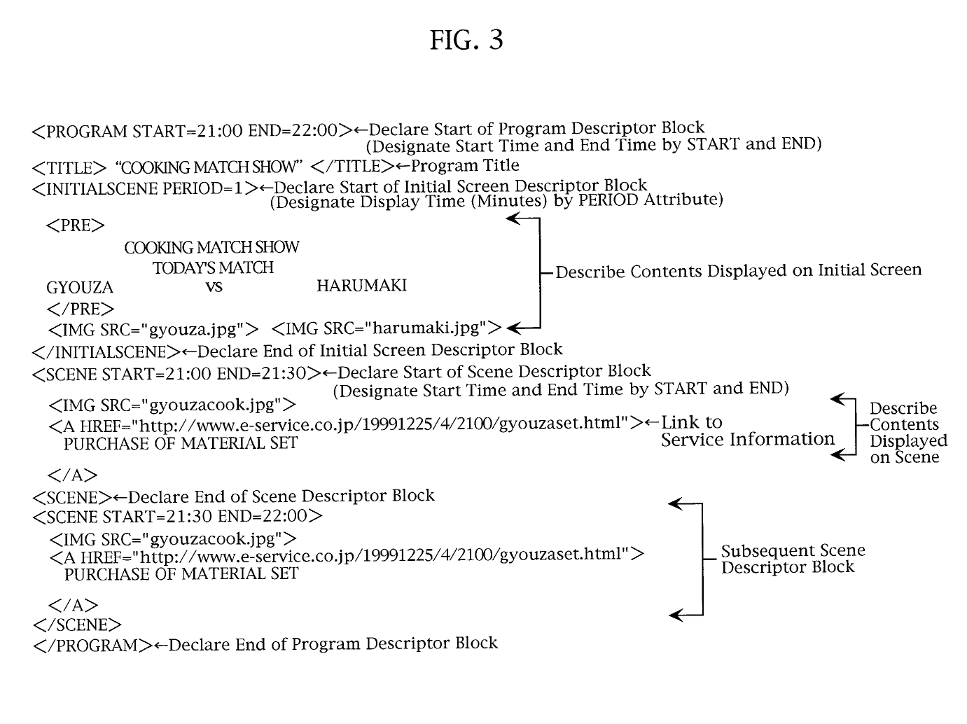

FIG. 3 illustrates an example of a description format for program-related information.

The program-related information is described in an HTML format in principle. In this example, the following tags are added:

(1) A tag representing the start and the end of an initial screen descriptor block (a block for describing information related to an initial screen displayed for a predetermined time period at the beginning of program selection (initial screen description information))

<INITIALSCENE PERIOD=00>˜</INITIALSCENE>

00: time period during which initial screen is displayed (unit: minute)

(2) A tag representing the start and the end of a scene descriptor block (a block for describing information displayed only for a defined time period (scene description information))

<SCHENE START=0000 END=XXXX>˜</CHANNEL>

0000: display start time

XXXX: display end time

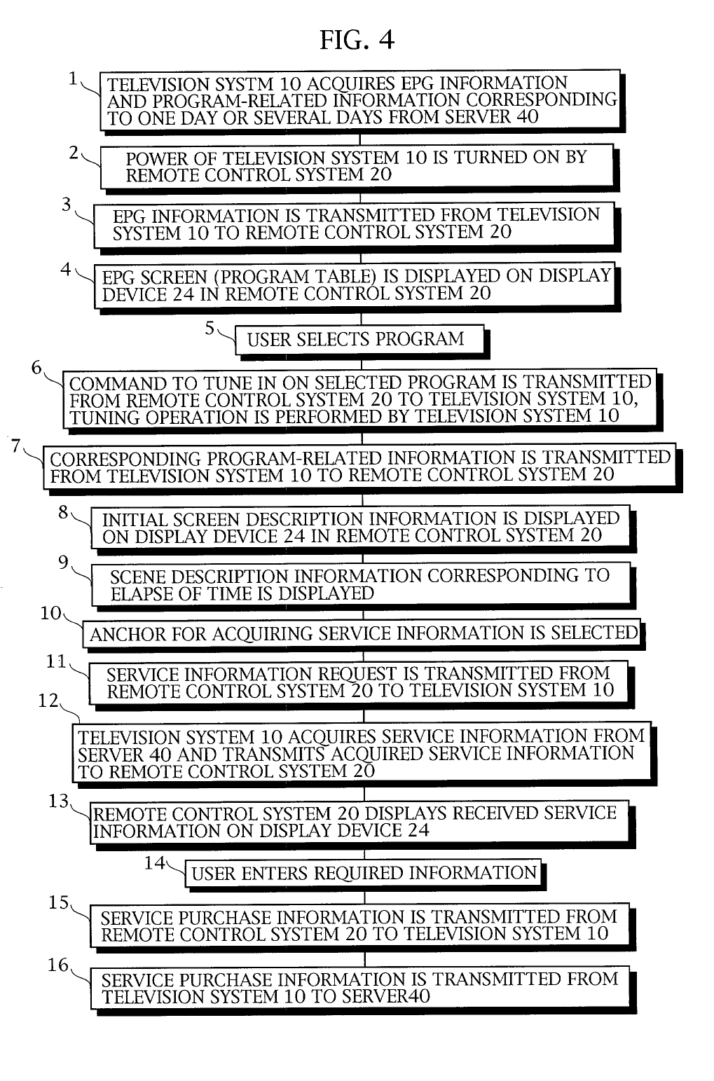

FIG. 4 illustrates an example of the procedure for service utilization by a service providing system.

The television system 10 first downloads from the server 40 EPG information and program-related information corresponding to one day or several days, and stores the information in the storage device 14 (step 1).

When the power of the television system 10 is turned on by the remote control system 20 (step 2) the EPG information is transmitted to the remote control system 20 (step 3), and an EPG screen (a program table) is displayed on a display device 24 in the remote control system 20 (step 4).

When a user selects a program which a user desires to view on the EPG screen (step 5), a command to tune in on the selected program is transmitted to the television system 10 from the remote control system 20. Accordingly, the television system 10 tunes in on the program selected by the user (step 6). Consequently, an image of the program selected by the user is displayed on the display device 12 in the television system 10.

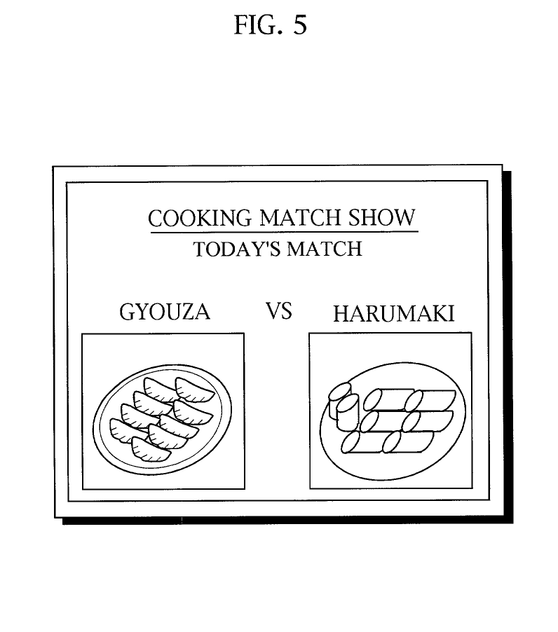

On the other hand, the television system 10 transmits the program-related information corresponding to the program selected by the user to the remote control system 20 (step 7). The remote control system 20 displays initial screen description information in the received program-related information on the display device 24 in the remote control system 20 (step 8). An example of an initial screen is illustrated in FIG. 5.

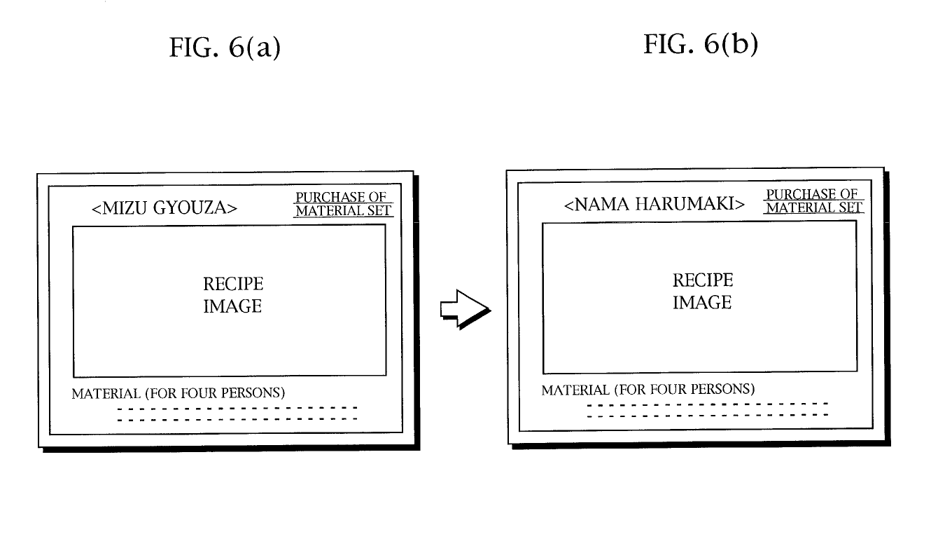

Thereafter, the remote control system 20 displays scene description information corresponding to an elapse of time of the program from the received program-related information on the display device 24 in the remote control system 20 (step 9). FIG. 6(a) and 6(b) respectively illustrate scene description information displayed when the time is PM 9:05 and scene description information displayed when the time is PM 9:30.

In such a state that the scene description information is displayed, when an anchor for acquiring service information (“purchase of a material set” in the example shown in FIGS. 6(a) and 6(b)) is selected (step 10), a service information request corresponding to the anchor (URL (Uniform Resource Location) at link destination) is transmitted to the television system 10 from the remote control system 20 (step 11). Accordingly, the television system 10 acquires service information corresponding to the service information request from the server 40 and transmits the acquired service information to the remote control system 20 (step 12).

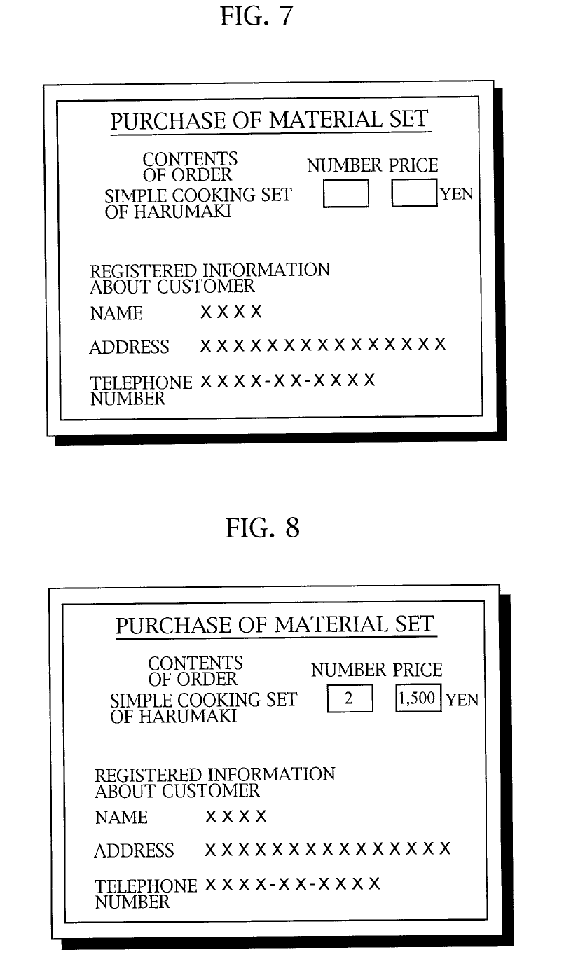

The remote control system 20 displays, when it receives the service information fed from the television system 10, the service information on the display device 24 in the remote control system 20 (step 13) FIG. 7 illustrates an example of display of the service information (a screen for purchasing a material set).

When the user enters information required to purchase a service, as shown in FIG. 8, on the basis of a screen on which the service information is displayed (step 14), the service purchase information is transmitted to the television system 10 from the remote control system 20 (step 15), and is transmitted to the server 40 from the television system 10 (step 16).

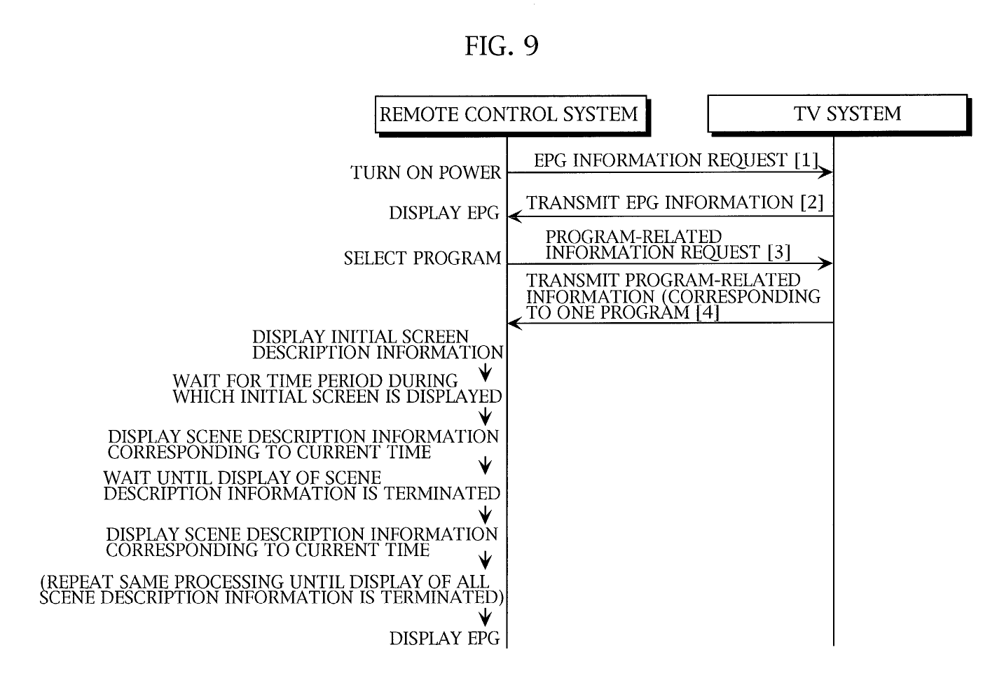

FIG. 9 shows the procedure for communication between the remote control system 20 and the television system 10 which is established in order to display program-related information.

When the power of the television system 10 is turned on by the remote control system 20, the remote control system 20 transmits an EPG information request to the television system 10 (a sequence number [1]).

The television system 10 transmits, when it receives the EPG information request, EPG information to the remote control system 20 (a sequence number [2]). The remote control system 20 displays, when it receives the EPG information, an EPG screen on the display device 24.

When a predetermined program (a channel) is selected by the user on the basis of the EPG screen, the remote control system 20 transmits a program-related information request using a channel number and a program name as arguments to the television system 10 (a sequence number [3]).

The television system 10 transmits, when it receives the program-related information request, the program-related information related to the program to the remote control system 20 (a sequence number [4]).

The remote control system 20 displays, when it receives the program-related information request, initial screen description information on the basis of the program-related information. The remote control system 20 displays scene description information corresponding to the current time after waiting only for a time period during which an initial screen is displayed. It displays the scene description information corresponding to the current time after waiting until the time when the display of the scene description information is terminated. The same processing is repeated until the display of all the scene description information related to the program is terminated. The remote control system 20 displays the EPG screen when the display of all the scene description information related to the program is terminated.

In a case where the program-related information is displayed on the display device 24, when the user switches a channel, the processing assigned the sequence number [3] is performed again.

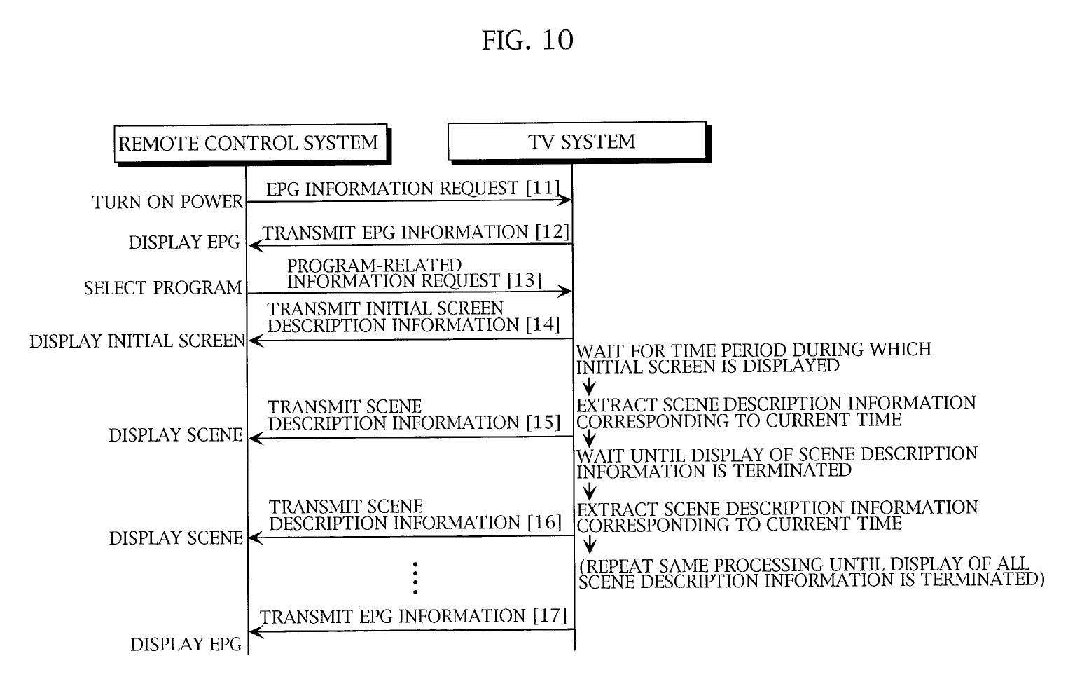

When the remote control system 20 does not comprise a storage device and an internal clock device, the procedure for communication between the remote control system 20 and the television system 10 is as shown in FIG. 10.

When the power of the television system 10 is turned on by the remote control system 20, the remote control system 20 transmits an EPG information request to the television system 10 (a sequence number [11]).

The television system 10 transmits, when it receives the EPG information request, EPG information to the remote control system 20 (a sequence number [12]). The remote control system 20 displays, when it receives the EPG information, an EPG screen on the display device 24.

When a predetermined program (a channel) is selected by a user on the basis of the EPG screen, the remote control system 20 transmits to the television system 10 the program-related information request using a channel number and a program name as arguments (a sequence number [13]).

The television system 10 transmits, when it receives the program-related information request, the initial screen description information in the program-related information related to the program to the remote control system 20 (a sequence number [14]). The remote control system 20 displays, when it receives the initial screen description information, an initial screen on the display device 24.

The television system 10 waits, when it transmits the initial screen description information to the remote control system 20, only for a time period during which the initial screen is displayed, and then extracts scene description information corresponding to the current time, to transmit the extracted scene description information to the remote control system 20 (a sequence number [15]). The remote control system 20 displays, when it receives the scene description information, the scene description information on the display device 24.

The television system 10 waits, when it transmits the scene description information to the remote control system 20, until the display of the scene description information is terminated, and then extracts scene description information corresponding to the current time, to transmit the extracted scene description information to the remote control system 20 (a sequence number [16]). The remote control system 20 displays, when it receives the scene description information, the scene description information on the display device 24.

The television system 10 and the remote control system 20 repeat the same processing until the display of all scene description information related to the program is terminated.

When the display of all the scene description information related to the program is terminated, the television system 10 transmits the EPG information to the remote control system 20 (a sequence number [17]). The remote control system 20 displays, when it receives the EPG information, the EPG screen on the display device 24.

In a case where the program-related information is displayed on the display device 24, when the user switches a channel, the processing assigned the sequence number [13] is performed again.

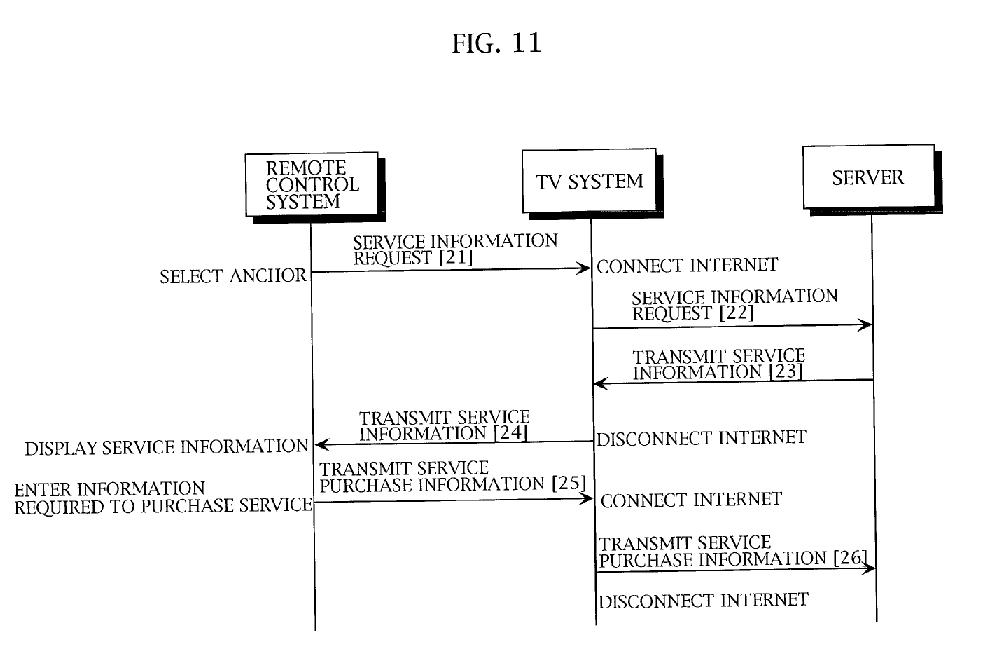

FIG. 11 shows the procedure for communication among the remote control system 20, the television system 10, and the server 40 in a case where service information is acquired from the server and displayed and a case where service purchase information is transmitted to the server.

In a state where program-related information is displayed on the display device 24 in the remote control system 20 when an anchor for acquiring the service information is selected, a service information request corresponding to the anchor is fed to the television system 10 from the remote control system 20 (a sequence number [21]).

The television system 10 performs, when it receives the service information request, an Internet connecting operation, and then transmits the service information request to the server 40 (a sequence number [22]).

The server 40 transmits, when it receives the service information request, service information corresponding to the service information request to the television system 10 (a sequence number [23]).

The television system 10 performs, when it receives the service information, an Internet disconnecting operation, and transmits the service information to the remote control system 20 (a sequence number [24]).

The remote control system 20 displays, when it receives the service information, the service information on the display device 24. In this state, when the user enters information required to purchase a service, the remote control system 20 transmits the service purchase information to the television system 10 (a sequence number [25]).

The television system 10 performs, when it receives the service purchase information, an Internet connecting operation, and then transmits the service purchase information to the server 40 (a sequence number [26]). Thereafter, the television system 10 performs an Internet disconnecting operation.

Although in the above-mentioned embodiment, the television system 10 has the function of acquiring the program-related information and the service information from the server, the remote control system 20 may have the function of acquiring the program-related information and the service information from the server.

Although in the above-mentioned embodiment, the program-related information and the service information are displayed on the display device 24 in the remote control system 20, they may be displayed as a small screen on the display device 12 in the television system 10.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. A television receiver comprising:
means for acquiring program-related information held in a first server connected to a network and related to the contents of each program corresponding to a predetermined time period and including link information for acquiring detailed information held in a second server connected to the network from the first server through the network and storing the acquired program-related information;
means for displaying, when the program is selected by a user, the program-related information corresponding to the program on a television monitor;
means for acquiring, when an anchor for the link information included in the displayed program-related information is selected by a user operation, the detailed information from the second server through the network on the basis of the link information; and
means for displaying the acquired detailed information on the television monitor.

2. A television receiver comprising:
means for acquiring program-related information held in a first server connected to a network and related to the contents of each program corresponding to a predetermined time period from the first server through the network and storing the acquired program-related information; and
means for displaying, when the program is selected by a user, the program-related information corresponding to the program on a display device provided in a remote controller for the television receiver.

3. The television receiver according to claim 2, further comprising
means for acquiring EPG information related to a program schedule corresponding to a predetermined time period from a second server connected to the network and storing the acquired EPG information; and
means for displaying, when the power is turned on or a program which is being viewed is terminated, a program table created on the basis of the ERG information on the display device provided in the remote controller for the television receiver.

4. The television receiver according to claim 2, wherein
the program-related information includes program-related information for each elapsed time period in each program.

5. The television receiver according to claim 3, wherein
the program-related information includes program-related information for each elapsed time period in each program.

6. The television receiver according to claim 2, wherein the program-related information includes link information for acquiring detailed information held in a third server connected to the network, further comprising
means for acquiring, when an anchor for link information is selected by a user operation, detailed information from the third server through the network on the basis of the link information, and
means for displaying the acquired detailed information on the display device provided in the remote controller for the television receiver.

7. The television receiver according to claim 3, wherein the program-related information includes link information for acquiring detailed information held in a third server connected to the network, further comprising
means for acquiring, when an anchor for the link information is selected by a user operation, the detailed information from the third server through the network on the basis of the link information, and
means for displaying the acquired detailed information on the display device provided in the remote controller for the television receiver.

8. A remote controller for a television receiver, comprising:
a display device;
means for acquiring program-related information related to the contents of each program corresponding to a predetermined time period from a first server connected to a network and storing the acquired program-related information; and
means for displaying, when the program is selected by a user, the program-related information corresponding to the program on the display device.

9. The remote controller for a television receiver according to claim 8, further comprising
means for acquiring EPG information related to a program schedule corresponding to a predetermined time period from a second server connected to the network and storing the acquired EPG information, and
means for displaying, when the power is turned on or a program which is being viewed is terminated, a program table created on the basis of the EPG information on the display device.

10. The remote controller for a television receiver according to claim 8, wherein
the program-related information includes program-related information for each elapsed time period in each program.

11. The remote controller for a television receiver according to claim 9, wherein
the program-related information includes program-related information for each elapsed time period in each program.

12. The remote controller for a television receiver according to claim 8, wherein the program-related information includes link information for acquiring detailed information held in a third server connected to a network, further comprising
means for acquiring, when an anchor for the link information is selected by a user operation, the detailed information from the third server through the network on the basis of the link information, and
means for displaying the acquired detailed information on the display device.

13. The remote controller for a television receiver according to claim 9, wherein the program-related information includes link information for acquiring detailed information held in a third server connected to the network, further comprising
means for acquiring when an anchor for the link information is selected by a user operation, the detailed information from the third server through the network on the basis of the link information, and
means for displaying the acquired detailed information on a display device.

14. In a service providing system comprising a television receiver having a first server connected to a network and holding program-related information related to the contents of each program, a second server holding detailed information, and a network connecting function, the program-related information including link information for acquiring the detailed information,
the television receiver comprises
means for acquiring the program-related information related to the contents of each program corresponding to a predetermined time period from the first server and storing the acquired program-related information,
means for displaying, when the program is selected by a user, the program-related information corresponding to the program on a television monitor;
means for acquiring, when an anchor for the link information included in the program-related information is selected by a user operation, the detailed information from the second server on the basis of the link information, and
means for displaying the acquired detailed information on the television monitor.

15. In a service providing system comprising a television receiver having a first server connected to a network and holding program-related information related to the contents of each program, a second server holding detailed information, and a network connecting function, the program-related information including link information for acquiring the detailed information,
the television receiver comprises
means for acquiring the program-related information related to the contents of each program corresponding to a predetermined time period from the first server and storing the acquired program-related information,
means for displaying, when the program is selected by a user, the program-related information corresponding to the program on a display device provided in a remote controller for the television receiver;
means for acquiring, when an anchor for the link information included in the program-related information is selected by a user operation, the detailed information from the second server on the basis of the link information, and
means for displaying the acquired detailed information on the display device provided in the remote controller for the television receiver.

16. In a service providing system comprising a remote controller for a television receiver having a first server connected to a network and holding program-related information related to the contents of each program, a second server holding detailed information, and a network connecting function, the program-related information including link information for acquiring the detailed information,
the remote controller for the television receiver comprises
means for acquiring the program-related information related to the contents of each program corresponding to a predetermined time period from the first server and storing the acquired program-related information,
means for displaying, when the program is selected by a user, the program-related information corresponding to the program on the display device;
means for acquiring, when an anchor for the link information included in the program-related information is selected by a user operation, the detailed information from the second server on the basis of the link information, and
means for displaying the acquired detailed information on the display device.

17. The service providing system according to claim 14, wherein
the detailed information includes commodity purchase information.

18. The service providing system according to claim 15, wherein
the detailed information includes commodity purchase information.

19. The service providing system according to claim 16, wherein
the detailed information includes commodity purchase information.
